(19) United States
(12) Patent Application Publication
(10) Pub. No.: US 2012/0011072 A1
(43) Pub. Date: Jan. 12, 2012

(54) Method, System, And Computer Program Product For Facilitating Post-Sale Transactions Using Mobile Devices

(75) Inventor: Francesco Lodolo, London (GB)

(73) Assignee: NOKIA CORPORATION, Espoo (FI)

(21) Appl. No.: 12/521,737

(22) PCT Filed: Dec. 28, 2007
(86) PCT No.: PCT/GB07/05009

§ 371 Date: Jul. 18, 2011

(30) Foreign Application Priority Data
Dec. 29, 2006 (GB) 0626028.5

(51) Int. Cl. G06Q 30/00

(52) U.S. Cl. 705/302; 705/304

(57) ABSTRACT

The present invention provides a technique for securely identifying devices that can interact by wired or wireless communication protocols. An transaction object is generated which contains details of an interaction between a pair of devices. The transaction object can subsequently be transferred to other devices to provide details of the interaction, thereby enabling the identity of the sending device to be determined by the receiving device, as well as other relevant information.

### CROSS-REFERENCE TO RELATED APPLICATIONS

This application is based on, and claims priority to, Great Britain Application No. GB 0626028.5, filed Dec. 29, 2006, the entire contents of which are fully incorporated herein by reference.

### BACKGROUND OF THE INVENTION

This invention relates to a mechanism for facilitating data transfer and storage between two electronic devices and, in a preferred embodiment, between a portable device carried by a consumer and an essentially-stationary device used by a merchant. In the present discussion the term “portable device” is intended to include, without being limited to, laptop computers, Personal Digital Assistants (PDAs), mobile telephones, Smartphones, digital music or video players, and any other devices designed for portability and which are useable to execute a purchase electronically. It also includes converged devices incorporating the functionality of one or more of the classes of device already mentioned.

In recent years, portable consumer electronic devices have become increasingly interwoven with our everyday lives. Such devices are illustrated by way of example in FIG. 1, and include portable computers, such as laptops 2, Smartphones or mobile/cellular phones 4, personal digital assistants (PDAs) 6, with or without wireless e-mail capabilities, music or video players 8, and portable storage devices, such as USB smart keys 14. While most electronic devices can operate independently of other devices, often they are used most effectively in conjunction with larger devices that provide alternative processing or storage capacity, such as a personal computer 16. A simple example is a Smartphone. Although a Smartphone provides a user with portable access to a telephone, calendar, contact list, to-do list, etc., they typically are synchronizable with a desktop or laptop computer, or a server, so that a backup of the data always exists in the event that the Smartphone is damaged or the data thereon is destroyed or corrupted. Additionally, when large amounts of data are to be input for use on the Smartphone, it can often be easier to input the data on the full-size keyboard available via the desktop or laptop computer.

Recent developments in technologies for inter-device connectivity have greatly benefited manufacturers, software providers, and consumers alike by allowing file and/or data transfer to easily occur between different devices. Presently, there are a number of different technologies for connecting devices together.

Connections to home computing devices typically make use of wired serial connections on both devices. Such connectivity is sometimes described as short link, local transmission link, or a Personal Area Network (PAN) because the devices must be placed in proximity to one another for a connection to be possible. One such technology, called Universal Serial Bus (USB), refers to the combination of a cable, corresponding specialised ports on the computer and device, and signalling protocols, the combination of which allows data signals and power to be transferred between devices. Both the computer and the portable device typically provide software support for the data transmission protocols along the cable. USB technology has greatly improved device connectivity as its operation is often automatic. USB technology is well-known and it is not necessary to provide additional description of this technology for this reason.

Wireless connections between devices are also known. One such technology is Bluetooth technology. As is well-known, a Bluetooth-enabled device has a radio frequency transmitter and receiver, and the necessary driving software for transmitting signals to and receiving signals from another Bluetooth enabled device. Some Bluetooth devices have a range of up to 100 m. The software on the device performs the encoding/decoding of data, and ensures that the signals are transmitted correctly according to the relevant transmission protocol. Other technologies for transmitting data between devices include Infrared transmitter and receiver protocols provided by the Infrared Data Association (IrDA), and WiFi for example. One protocol for data transmission used with Bluetooth and IrDA is known as OBEX, short for Object Exchange; this is a communication protocol that allows the exchange of binary objects between devices.

Consumers are now beginning to be able to carry out “electronic purchases” using connections between computing devices. Such technology is relatively new to the market-place, but for example, in Japan it is known to use mobile phones to buy goods (typically by adding the cost of the goods to a user's mobile phone account) and in Scandinavian countries it is known to use SMS messages to perform sales of items such as cans of drink from vending machines.

In view of the increasing availability of wireless connections between devices, and especially in the context of sales of goods and services using such connections, the applicant herein has appreciated that post-sale activities, such as storing and tendering of receipts when needed (e.g., to facilitate a return of a purchased item) and the storage of warranty information specific to a particular purchase from a particular merchant location and the ability to use this stored information in exercising the terms of the warranty is desirable and needed.

### SUMMARY OF THE INVENTION

According to a first aspect of the present invention there is provided a method, apparatus, and computer program product for facilitating post-sale transactions, whereby an electronic transaction object is generated based on a sales transaction executed between a first device and a second device; the transaction object is transferred from the second device to the first device, the electronic transaction object specifying details of the sales transaction; a post-sale transaction is initiated between the first device and a third device; the electronic transaction object is transferred, during the post-sale transaction, from the first device to the third device; and in response to receiving the electronic transaction object at the third device, a post-sale event associated with the electronic transaction object is automatically initiated.

The electronic transaction object can comprise, for example, an electronic receipt evidencing the sales transaction or warranty information pertaining to the sales transaction.

Further, the post-sale event can comprise, for example, a return associated with the sales transaction or the exercising of a warranty identified in the warranty information.

The second device and the third device could be the same device, or the third device and the second device could be electronic points of sale associated with the same supplier of goods or services.

The details specified in the electronic transaction object could include one or more of: the date of the first interaction; the time of the first interaction; an expiry time associated with the transaction; an identification of goods or services provided to a user of the second device; the identity of the first device; the identity of the second device; and conditions pertaining to the transaction.

The method could further comprise the step of initiating a reminder to a user of the first device on the basis of the details specified in the electronic transaction object.

### BRIEF DESCRIPTION OF THE DRAWINGS

It will be understood by a skilled person that the general concept of the invention may be utilised in a number of different applications. Uses can be envisaged in, for example: authenticating the transfer of a data file from one device to another; enabling subscriptions to electronic journals or magazines; tracking vehicle maintenance requirements; and enabling electronic refunds of electronically purchased goods or services. Some of these examples will be discussed in detail below with reference to the accompanying drawings, in which:

FIG. 1 is an illustration of example electronic devices that may be used with the preferred embodiment of the invention;

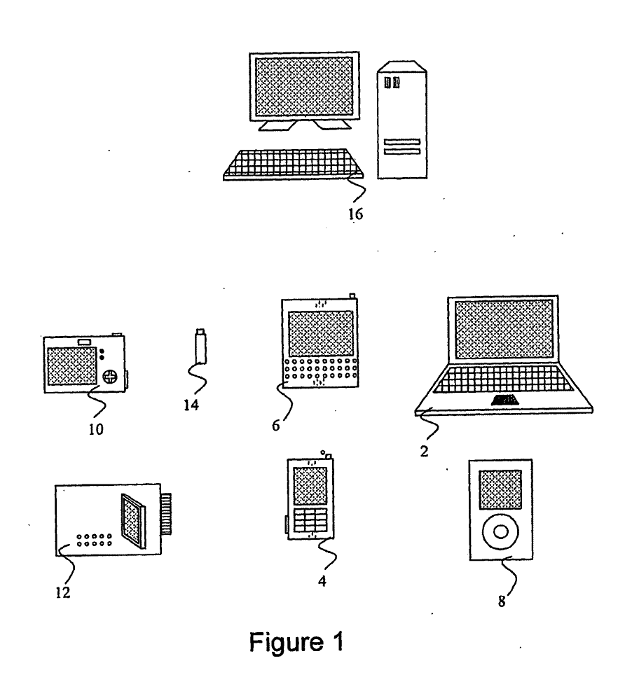

FIG. 2 is a schematic illustration of an object or token that is exchanged to record information about the nature of the device interaction;

FIG. 3 is an illustration of an example application of the invention in a system for facilitating data transfer between two devices;

FIG. 4 is an illustration of an example application of the invention in an electronic payment system; and

FIG. 5 is a flowchart illustrating basic steps performed in accordance with the present invention.

### DETAILED DESCRIPTION OF THE PREFERRED EMBODIMENTS

The preferred embodiment of the invention involves the use of an electronic object or token, hereinafter called transaction object, that is exchanged between two devices at the point of interaction as part of a transaction between them. The two devices are interactively coupled by wireless or wired link, such as by using a USB connector directly from one to another, or by establishing a personal area network on which the devices can communicate directly. The transaction object records details of the transaction that occurs between the devices, as well as any related conditions that may be appropriate to the transaction. Corresponding control processes are also provided for generating such objects, transferring them between devices during transactions, and controlling the devices in response.

The preferred transaction object and control processes are implemented in an object oriented programming language such as C++ or Java, though any other suitable programming language may be employed.

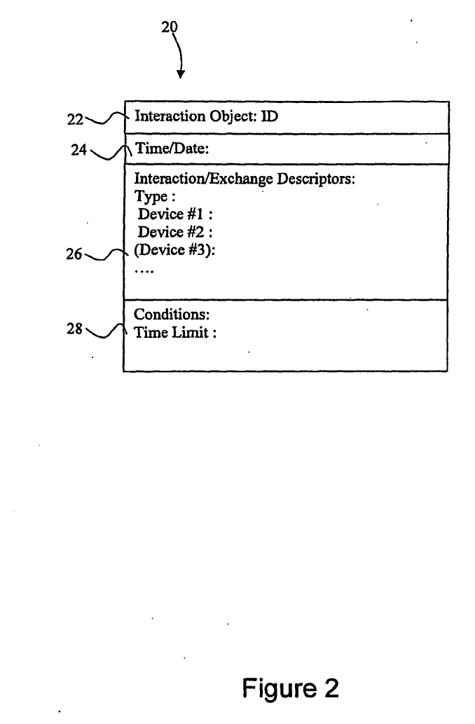

FIG. 2 schematically illustrates the structure of the data fields within the transaction object 20 of the preferred embodiment. The object has a header 22 that both identifies it as a transaction object, and that contains a unique identifier for reference purposes. The identifier may, for example, be a Globally or Universally Unique ID (GUID or UUID) as are known in the art. The object also contains a time and/or date field 24 for storing the date on which the transaction occurred, one or more descriptor fields 26 for defining the nature of the transaction, and one or more condition fields 28 for storing any appropriate conditions that have a bearing on the transaction or exchange.

The descriptor fields shown in FIG. 2 allow the object to store an indication of the transaction type, and the two devices involved in the interaction. A field indicating a third device may also be included, as will be explained below. The condition fields may be used to express any conditional statements that relate to the object, such as a time limit field for monitoring further action or validity. The fields shown in FIG. 2 are purely for illustration, and are not intended to be limiting.

The data stored in the fields of the transaction object is arranged to be at least computer readable by corresponding software or code on a receiving or issuing electronic device. In this way, the data in the fields may be used to produce operational effects within the devices once it is read by a device and interpreted by a device. Additionally, the data stored in the transaction object may be human-readable, such as ASCII text, so that a user of an electronic device can view the transaction object and recall a description of the transaction, and any conditions relating to it. The human readable data itself need only be stored in the transaction object if the transaction object is to be viewed using standard ASCII text based programs, such as word processing based systems. Alternatively, special viewing software may be provided, that simply translates the computer readable data in the transaction object into meaningful data for a user. Thus, it will be appreciated that information such as the date of the transaction could be stored as part of the identifier 22, and that this date field could be omitted from the transaction object.

The transaction object is intended to cooperate with dedicated control processes or software provided in one or all of the electronic devices. The control software is necessary to create the transaction objects, and to read instances of such objects to determine if any actions are necessary. The details of the transaction stored in the object can include descriptive parameters describing properties of the transaction or data being transferred, parameters that identify the devices involved in the transaction, and conditions such as time periods that run from the time the object is created.

### Secure Data Transfer

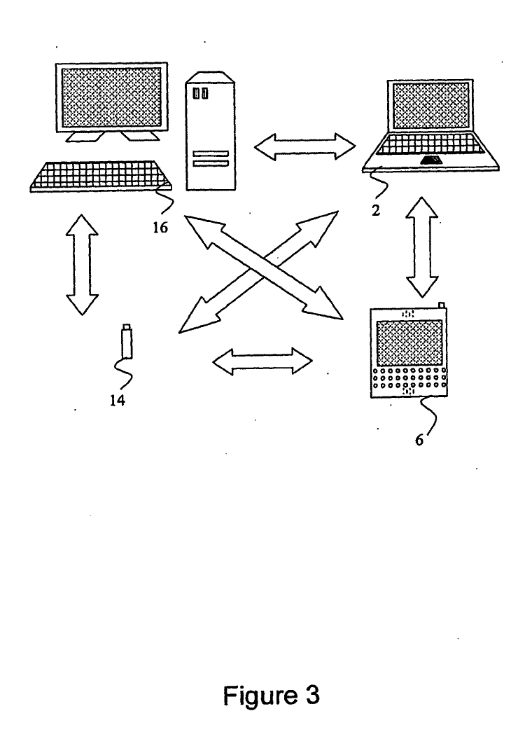

In one embodiment of the invention, transaction objects may be used as authorisation or authentication tokens to securely identify one device to another device. This embodiment will be described with reference to FIG. 3.

A portable computing device 6 is used by a user to interact with a personal computer 16, as indicated by the arrow 30, by Bluetooth. Data is exchanged during this transaction which identifies the portable device 6 to the PC 16. A password is required so that the PC can recognise the portable device as a trusted device. In this example, the portable device is a mobile phone of an employee of a company, and the PC 16 is the employee's desktop computer in his office. The employee enters information into his phone to specify certain requests. Here, he identifies particular document to which he requires access. When the PC has successfully recognised the employee's password, it generates a token (“transaction object”) which it sends to the phone. The token contains details of the time and date of the authentication as well as information about the employee's permissions, including access to the specified document.

Some time later, the employee carries his phone to a different building owned by the employer, in which he has access to a different computer 2. This second computer is connected to PC 16 by means of a network indicated in FIG. 3 by the arrow 31. The employee wishes to obtain a copy of the latest version of the specified document from the network 21. To achieve this, he connects his phone by Bluetooth to the computer 2 (arrow 32), locates the previously acquired token on his phone, and transfers it (or a copy of it) to the computer.

When the computer receives the token, it analyses it to determine details of the first transaction with the PC 16. It recognises that the employee has requested access to the specified document, and automatically arranges for the latest version of the document, as stored on the network, to be transferred to the employee's phone. In this way, the employee has conveniently received an up-to-date copy of the document which he can read or amend using his phone.

### Electronic Payment Systems

In a preferred embodiment, the present invention is employed in technology that facilitates electronic payment methods. An electronic wallet, for example, is a known electronic device that acts as a repository for electronic cash and that interacts with special Point of Sale (POS) devices in stores to make a payment. The actual cash that an electronic wallet holds may be stored in a remote account that the electronic device accesses at the point of sale, or it may be encoded on the device so that the POS device simply deducts the amount paid for goods or services from the sum stored at the end of the transaction.

Wallet phones are one example of such electronic devices. These are mobile or cellular phones that allow a user to pay by wirelessly connecting their phone to a Point of Sale (POS) terminal in the store.

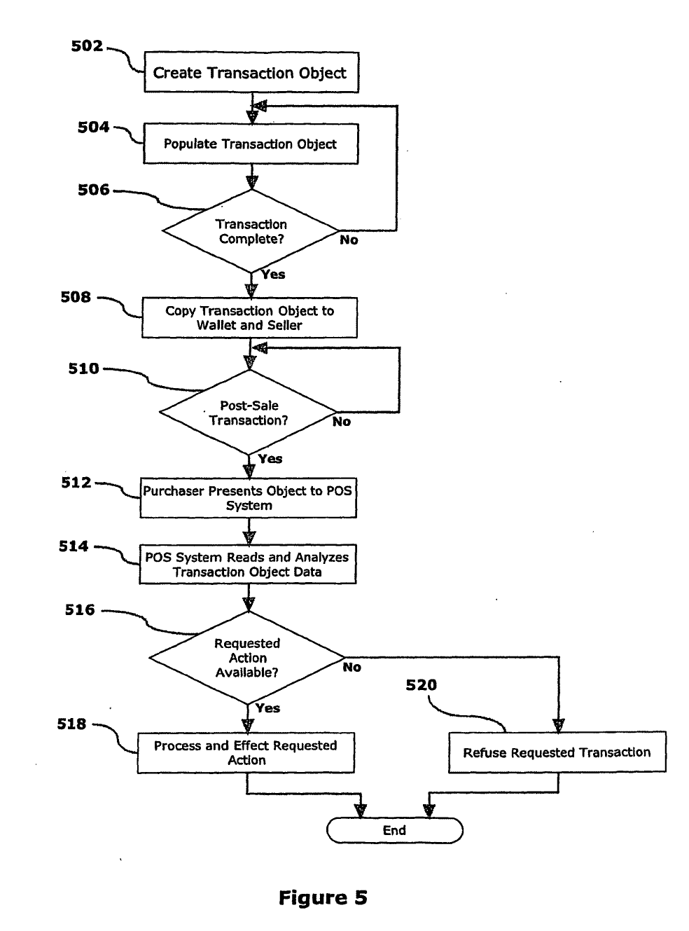

The transaction object can be advantageously used in this environment to record details of a monetary transaction that has occurred, and act as an electronic receipt which may be stored on both the electronic wallet and the POS device. FIG. 5 is a flowchart illustrating basic steps performed in accordance with the present invention. Thus, in the first interaction between the electronic wallet and the POS device, an electronic sale takes place, and a transaction object is created (step 502). In this example, a relatively expensive item is bought, such as a digital camera. The transaction object is populated with the date, the device details of the electronic wallet, an identifier of the issuing POS terminal, the address of the issuing store, details of the camera, price information, and conditions under which the camera may be returned to the retailer for an exchange or refund (step 504). When the sale is completed (step 506), a copy of the transaction object is transferred to the electronic wallet and stored for later reference. In the store terminal, a copy of the transaction object is stored for stock management and auditing purposes (step 508). It is understood that the population information referred to above is for purposes of example and any information concerning the transaction and item(s) involved in the transaction can be included, and that other copies can be stored at other locations.

At step 510, it is determined if a post-sale transaction, e.g., a refund, warranty request, etc., is desired by the user. In this example, after the purchase has been made the customer decides that he wishes to perform a post-sale transaction, in this case, to return the camera to the store from which he bought it and obtain a refund (step 510). He returns to a different branch of the store and connects (wirelessly, or if unavailable, wired) his electronic wallet to a POS terminal (step 512). He sends a copy of his electronic receipt to the POS terminal, which is configured to read the receipt and determine whether the camera is being returned within the agreed return period (steps 514 and 516). Since in this example the refund period is still active, the POS terminal automatically initiates a refund to be transferred to the account from which the customer originally made the purchase (step 518). In this example, a sales assistant is present to receive the camera from the customer and verify that it is still in good condition. If the refund period is not still active, this is identified at step 516 and the requested post-sale transaction is refused (step 520).

Using the transaction object in this way gives the store assurance that the purchase was legitimate, and allows the details of the refund to be processed automatically to ensure that the correct amount of money is returned. Often, for example, product/service prices will have changed in the period between the customer purchase and the refund, so that a store operator has to override the price that appears on the POS terminal automatically if only the product details are entered. Once the automatic refund has taken place, the transaction object can be deleted from the electronic wallet, and the object on the POS terminal updated to show that a refund has taken place.

For the customer, the transaction object acts as an electronic receipt that provides distinct functional advantages over a traditional paper copy. First, as the user of the electronic wallet is likely to have it with him at all times, the transaction object receipt is difficult to misplace. Further, if a control process is provided on the electronic wallet for interacting with the receipt, other functions can be realised, as will be described below.

One such enhancement is to automatically notify the customer when the period for refunding the product or services is about to expire. The transaction object acting as receipt stores the date of its creation, and if the electronic wallet has a date or appointment/organiser function, the control process can monitor how much time has elapsed since the transaction occurred, and issue a notification accordingly. The notification can be issued by the control process itself, or can be issued as a reminder in the appointment/organiser application. Furthermore, once the transaction object is no longer necessary, because the time period for a refund has expired, the control process in the electronic wallet can either automatically delete the transaction object, so that it no longer takes up space in memory, or ask the user to confirm whether or not it should be deleted.

The transaction object also allows different refund policies to be accommodated, in an easy to understand to manner for both the consumer and for the retailer. In comparison to a mere digital receipt, the transaction object in the Electronic Payment system may be configured to store the relevant refund policy and expiry date for the product or services purchased in a form that can be easily readable by the user of the electronic wallet via its resident control process. For example, it may contain the address of the store and specific constraints or rules about obtaining a refund in another store. Where stores operate under a franchise system, the refund policies in different stores may be different, and this information is advantageously stored in the Refund Object so that it can be viewed by the user via the electronic wallet, and so that if the user presents the Refund Object at a store under the same franchise, that store can either effect the refund, or decline based on the stored refund policy.

As noted above, the transaction object can have descriptors for storing conditions on which any further actions associated with the transaction object are based. One such condition that has been presented is a time limit. Another condition, that is appropriate to this example, might be that no refund is allowed. For example, if a product is sold at a greatly reduced price because it is defective in some way, the store might wish to prohibit the user from applying later for a refund. At the POS terminal, where the transaction object is created, it is therefore preferable if the retailer is provided with the option of adding conditions to the Object, such as ‘No Refund’ condition. Thus, if the user tries later to obtain a refund, they will be prohibited from doing so, by means of a data stored in the transaction object itself.

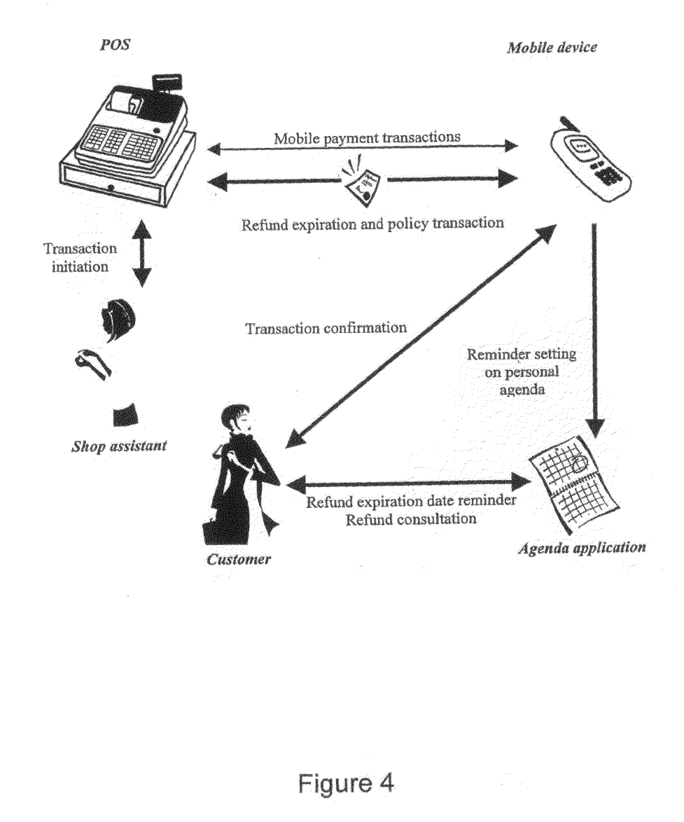

A schematic representation of an application of the transaction object in the context of electronic payment systems is provided in FIG. 4.

It should be noted that the transaction object could be used in a similar way to store and process warranty or guarantee information. The warranty information for a particular product can be included in the transaction object, thus enabling this information to be immediately available to any entity involved in the transaction in which one attempts to exercise the terms of a warranty. Just as with the refund information, the warranty information can be used to update calendars, issue reminders, etc., so that the user is made aware of the warranty expiration date and it's approach, if desired. Further, warranty conditions will also be immediately available to all parties involved in the transaction.

A further application of the concept of the transaction object can be envisaged in the context of subscriptions to electronic journals, magazines, newspapers or other informative products. In this example, a customer could identify himself to a provider of such subscriptions, provide electronic payment, and receive an transaction object specifying that a corresponding number of issues of a magazine are available to him. Then, when the customer subsequently wishes to receive an issue of the magazine, he can send a copy of his transaction object to the provider and receive an electronic (or paper) copy of the magazine in return. This arrangement offers the advantage that the customer need not receive issues of the magazine on a regular basis. Instead, he can receive a fixed number of issues at times he chooses. For example, he may choose only to receive the magazines while he is not too busy at work or when he is travelling.

### Device Maintenance

The transaction object described can also be used to ensure that an electronic or mechanical device such as a vehicle is operating correctly, by storing details of maintenance or service actions carried out to maintain the device at a first interaction, monitoring a time period set at the first interaction, and prompting a user to return to the device for a second interaction, in which a follow up action is taken.

In the example of vehicle maintenance a first interaction between a customer's phone and a POS terminal at a garage could occur to arrange payment for a vehicle test such as an MOT. An transaction object could be created by the POS terminal specifying the vehicle registration plate, the time and date of the test, and any further work carried out by the garage. The garage could offer a guarantee that any inadequate work carried out will be rectified free of charge if the resulting fault occurs within a certain time period after the initial work. This period could be specified in the transaction object.

After a service, if the customer's vehicle needs follow-up work to rectify inadequate work by the garage, the customer's phone could communicate with the POS terminal at the garage (or a different garage run by the same company) to transfer the transaction object holding details of the original service. The garage could thereby determine whether the further work needs to be carried out free of charge.

In the context of this example, the customer's phone could be arranged to read the transaction object to the extent necessary to issue a reminder at a particular time that, say, a next MOT is due, or a further service is required.

In the context of maintenance of electronic devices, the transaction object may be used to by a service engineer to monitor the internal state of a computer or network device. A portable electronic device carried by the engineer can be used to store, at a first interaction, a token including details of maintenance or configuration parameters applied to a computer, such as downloads, virus checking, memory defragmentatlon, inventory analysis and so on, and set goals for repeat checks. In this way, the engineer may be reminded that he should return to a computer for further servicing, and may also be prompted as to the nature of that servicing. Returning to the computer for a second interaction, the transaction object stored on the engineer's portable electronic device may be sent to the computer after connection, and may automatically cause the computer to initiate pre-installed servicing software.

In a network environment, the transaction object may be used to store details of an interaction between the engineer and a network device in which the configuration settings of the network device are altered. The transaction object may be stored at either the network device or the engineer's portable device, so that at a second interaction, the engineer can reset the network settings automatically using the transaction object. On connecting the portable electronic device to the network device, the respective control processes would identify the relevant prior transaction object using the unique device identifiers so that the configuration could be carried out automatically without much intervention from the engineer.

From the above examples it can be seen that many advantages can be achieved by using embodiments of the present invention in different contexts. The general inventive concept can enable convenient and secure transactions between devices, which may result in, among other things, the transfer of data, the sale or refund of goods or services, and the identification of required maintenance work. Other applications of the inventive concept may be conceived by the skilled person, all of which are within the scope of the present invention.

The above-described steps can be implemented using standard well-known programming techniques. The novelty of the above-described embodiment lies not in the specific programming techniques but in the use of the steps described to achieve the described results. Software programming code which embodies the present invention is typically stored in permanent storage. In a client/server environment, such software programming code may be stored with storage associated with a server. The software programming code may be embodied on any of a variety of known media for use with a data processing system, such as a diskette, or hard drive, or CD ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

It will be understood that each element of the illustrations, and combinations of elements in the illustrations, can be implemented by general and/or special purpose hardware-based systems that perform the specified functions or steps, or by combinations of general and/or special-purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, the figures support combinations of means for performing the specified functions, combinations of steps for performing the specified functions, and program instruction means for performing the specified functions.

While there has been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

1. A method of facilitating post-sale transactions, comprising:
generating an electronic transaction object based on a sales transaction executed between a first device and a second device;
transferring said transaction object from the second device to the first device, the electronic transaction object specifying details of the sales transaction;
initiating a post-sale transaction between the first device and a third device;
during the post-sale transaction, transferring the electronic transaction object from the first device to the third device; and
in response to receiving the electronic transaction object at the third device, automatically initiating a post-sale event associated with the electronic transaction object.

2. The method of claim 1, wherein said electronic transaction object comprises an electronic receipt evidencing said sales transaction.

3. The method of claim 2, wherein said post-sale event comprises a return associated with said sales transaction.

4. The method of claim 1, wherein said electronic transaction object comprises warranty information pertaining to said sales transaction.

5. The method of claim 4, wherein said post-sale event comprises exercising a warranty identified in said warranty information.

6. A method according to claim 1 wherein the sales transaction comprises an electronic sale of goods or services.

7. A method according to claim 6 wherein the electronic transaction object specifies details of said sale of goods or services.

8. A method according to claim 7 wherein said post-sale event is a refund event.

9. A method according to claim 3 wherein the second device is an electronic point of sale device.

10. A method according to claim 3 wherein the first device is a mobile phone.

11. A method according to claim 1 wherein the second device and the third device are the same device.

12. A method according to claim 11 wherein the third device and the second device are electronic points of sale associated with the same supplier of goods or services.

13. A method according to claim 1 wherein the details specified in the electronic transaction object include one or more of:
the date of the sales transaction;
the time of the sales transaction;
an expiry time associated with the said sales transaction;
an identification of goods or services provided to a user of the second device;
the identity of the first device;
the identity of the second device; and
conditions pertaining to the said sales transaction.

14. A method according to claim 1 further comprising the step of initiating a reminder to a user of the first device on the basis of the details specified in the electronic transaction object.

15. An apparatus for facilitating post-sale transactions, comprising:
means for generating an electronic transaction object based on a sales transaction executed between a first device and a second device;
means for transferring said transaction object from the second device to the first device, the electronic transaction object specifying details of the sales transaction;
means for initiating a post-sale transaction between the first device and a third device;
means for transferring, during the post-sale transaction, the electronic transaction object from the first device to the third device; and
means for automatically initiating a post-sale event associated with the electronic transaction object, in response to receiving the electronic transaction object at the third device.

16. A computer program product for facilitating post-sale transactions, the computer program product comprising a computer-readable storage medium having computer-readable program code embodied in the medium, the computer-readable program code comprising:
computer-readable program code that generates an electronic transaction object based on a sales transaction executed between a first device and a second device;
computer-readable program code that transfers said transaction object from the second device to the first device, the electronic transaction object specifying details of the sales transaction;
computer-readable program code that initiates a post-sale transaction between the first device and a third device;
computer-readable program code that transfers, during the post-sale transaction, the electronic transaction object from the first device to the third device; and
computer-readable program code that automatically initiates a post-sale event associated with the electronic transaction object, in response to receiving the electronic transaction object at the third device.
